(19) United States
(12) Patent Application Publication
(10) Pub. No.: US 2012/0131168 A1
(43) Pub. Date: May 24, 2012

(54) XDMS FOR RESOURCE MANAGEMENT IN M2M

(75) Inventor: George Foti, Dollard des Ormeaux (CA)

(73) Assignee: TELEFONAKTIEBOLAGET L M ERICSSON (PUBL), Stockholm (SE)

(21) Appl. No.: 13/301,382

(22) Filed: Nov. 21, 2011

Related U.S. Application Data
(60) Provisional application No. 61/416,175, filed on Nov. 22, 2010.
(60) Provisional application No. 61/431,173, filed on Jan. 10, 2011.
(60) Provisional application No. 61/431,174, filed on Jan. 10, 2011.

(51) Int. Cl. G06F 15/16

(52) U.S. Cl. 709/223

(57) ABSTRACT

The use of existing XDMS frameworks in M2M communications allows network functionality to be used and allows the obviation of redesign of resource management functionality.

### CROSS REFERENCE TO RELATED APPLICATIONS

This application claims the benefit of priority to U.S. Provisional Patent Application No. 61/416,175 filed Nov. 22, 2010; U.S. Provisional Patent Application No. 61/431,173 filed Jan. 10, 2011 and U.S. Provisional Patent Application No. 61/431,174 filed Jan. 10, 2011. The contents of these applications are expressly incorporated herein by reference.

### TECHNICAL FIELD

This disclosure relates generally to resource management in communications of machine to machine based devices.

### BACKGROUND

There is presently an increase in the number of machine-to-machine (M2M) devices being deployed by a variety of entities. These devices tend to be autonomous entities that employ wired or wireless access technologies to communicate information back to a server, or otherwise into a processing network. These devices are typically deployed to devices such as gas or water meters and other such devices, as well as to devices that are remote and cause difficulty in obtaining readings from. The advantages of deploying numerous M2M devices are well known and understood in the field.

In the telecommunications field, a number of services are made available to devices through the wireless and wired networks. These services are often not utilized by M2M communications as the devices are often designed to interact with a data structure designed by people not familiar with the functionality of the existing services, and without an understanding of how to modify the existing services to properly make use of them. As a result a large amount of existing functionality is duplicated. This not only increases development lead times, but also often results in inefficient use of limited bandwidth to perform functions that can be delegated to the network.

Therefore, it would be desirable to provide a system and method that obviate or mitigate problems associated with allowing the interaction of a plurality of M2M devices that are not under the management or control of a carrier, with carrier infrastructure.

### SUMMARY

It is an object of the present invention to obviate or mitigate at least one disadvantage of the prior art.

In accordance with a first aspect of the present invention, there is provided a method of facilitating communication between an unmanaged machine-to-machine device and a network resource in a managed network. The method comprises the steps of receiving a request for the resource from the unmanaged device; generating an Extensible Markup Language Configuration Access Protocol (XCAP) request in accordance with the received request; and transmitting the generated request towards an Extensible Markup Language Document Management Server (XDMS) using an asserted identity determined in accordance with identities of both the resource and the unmanaged device.

In an embodiment of the first aspect of the present invention, the step of receiving the request includes receiving a request in a format other than XCAP, and optionally the step of generating includes translating the request from a non-XCAP format to an XCAP format. In another embodiment, the step of transmitting further includes selecting an XDMS in accordance with the resource associated with the received request. In a further embodiment, the step of transmitting includes transmitting the generated request to an aggregation proxy associated with the XDMS.

In another embodiment, the method further includes the step of receiving a response from the XDMS. In a further embodiment, the received response is formatted as an XCAP response. In another embodiment the method includes the step of transmitting the received response to the unmanaged device, and can optionally include translating the response from an XCAP compliant format to a format selected in accordance with characteristics of the unmanaged device. In another embodiment, the step of receiving the response includes receiving the response from the XDMS via an aggregation proxy.

In accordance with a second aspect of the present invention, there is provided a Machine-to-Machine Service Capability Platform (M2M SC) for facilitating communication between an unmanaged machine-to-machine (M2M) device and a network resource in a managed network. The M2M SC comprises an M2M device interface, an XCAP request generator, a proxy identity assertion engine and an XDMS interface. The M2M device interface receives messages from and sends messages to the unmanaged M2M device. The Extensible Markup Language Configuration Access Protocol (XCAP) request generator receives a request for a resource from the unmanaged device, over the M2M device interface, and generates an XCAP compliant request in accordance with the received request to be transmitted to an Extensible Markup Language Document Management Server (XDMS) selected in accordance with the requested resource. The proxy identity assertion engine determines an identity associated with the request received in accordance with an identity of the unmanaged device. The XDMS interface sends the generated XCAP compliant request towards the selected XDMS using the determined identity, and receives responses from the selected XDMS.

In an embodiment of the second aspect of the present invention, the XDMS interface includes an Aggregation Proxy interface for transmitting the generated XCAP compliant request to an aggregation proxy when the selected XDMS is in a different network domain. In a further embodiment, the M2M SC further comprises a response handling engine for receiving a response from the selected XDMS over the XDMS interface, and for transmitting a response to the unmanaged device in accordance with the received response. Optionally, the response handling engine receives the response as an XCAP response and transmits the response to the unmanaged device in a non-XCAP format.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an exemplary architecture for the present invention;

FIG. 2 illustrates an alternate exemplary architecture for the present invention;

FIG. 3 illustrates a logical tree structure for documents and/or access rights;

FIG. 4 illustrates a logical tree structure for documents and/or access rights;

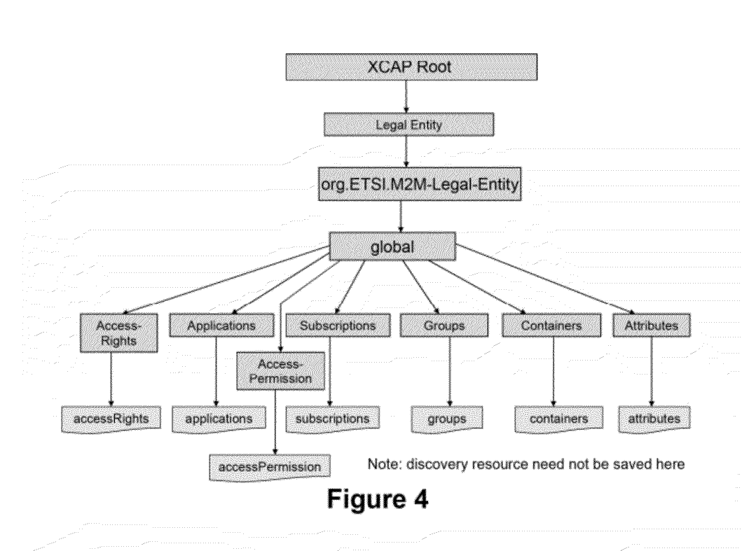

FIG. 5 illustrates a logical tree structure for documents and/or access rights;

FIG. 6 illustrates a logical tree structure for documents and/or access rights;

FIG. 7 illustrates a logical tree structure for documents and/or access rights;

FIG. 8 illustrates a logical tree structure for documents and/or access rights;

FIG. 9 illustrates a logical tree structure for documents and/or access rights;

FIG. 10 illustrates a logical tree structure for documents and/or access rights;

FIG. 11 illustrates a logical tree structure for documents and/or access rights;

FIG. 12 illustrates a logical tree structure for documents and/or access rights;

FIG. 13 illustrates a logical tree structure for documents and/or access rights;

FIG. 14 illustrates a logical tree structure for documents and/or access rights;

FIG. 15 illustrates a logical tree structure for documents and/or access rights;

FIG. 16 illustrates a logical tree structure for documents and/or access rights;

FIG. 17 illustrates a logical tree structure for documents and/or access rights;

FIG. 18 illustrates a logical tree structure for documents and/or access rights;

FIG. 19 illustrates a logical tree structure for documents and/or access rights;

FIG. 20 illustrates a logical tree structure for documents and/or access rights;

FIG. 21 illustrates a logical tree structure for documents and/or access rights;

FIG. 22 illustrates a logical tree structure for documents and/or access rights;

FIG. 23 illustrates a logical tree structure for documents and/or access rights;

FIG. 24 illustrates a logical tree structure for documents and/or access rights;

FIG. 25 is a control flow diagram illustrating a method of facilitating communication between an unmanaged M2M device and a network resource;

FIG. 26 is a control flow diagram illustrating a method of facilitating communication between an unmanaged M2M device and a network resource through an aggregation proxy; and

FIG. 27 is a block diagram illustrating an exemplary M2M Service Capability Platform (M2M SC).

### DETAILED DESCRIPTION

The present invention is directed to a framework allowing M2M devices to make use of existing XDMS functionality.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In a carrier grade environment, the use of an XDMS allows nodes trusted by the carrier to access data in a secure and trusted fashion. Typically, the XDMS is accessed using an XML Configuration Access Protocol (XCAP) based request. In an environment where there are a limited number of applications, and a high degree of carrier control over the nodes on which the applications are executed, this is a near ideal architecture. XDMS resources are stored in a manner that allows for a per-application access level control, and there are a limited number of nodes that can access the XDMS.

As a shift to M2M devices has occurred, it has become clear that the current architecture has problems when there are a large number of nodes that are running applications. In an M2M environment, each M2M device is capable of running at least one application. To provide the carrier with security, it is preferable that the M2M devices and their respective applications not be able to directly access the XDMS. Further problems are raised when an application access the network through a first carrier and needs access to the XDMS services hosted by a second carrier.

Adding to the problem is that many carrier environments make use of the Internet Multimedia Subsystem (IMS) for access to resources hosted by the XDMS. However, M2M devices are manufactured by a variety of different entities, and not all of the devices will make use of IMS access procedures. Instead, many existing M2M devices are simply provided with an IP stack and a set of commands and instructions that they are responsive to. This creates a mismatch both in the ability of the devices to connect to the network, and the ability of the network to allow connections from the many devices.

In the following discussion, an architecture for an enhanced XDMS framework is discussed, which makes use of a new directory structure for access rights. Additionally, a mechanism for a M2M Service Capability Platform to act as a proxy between the devices and the XDMS is introduced to allow the M2M devices to access the XDMS resources without breaking the security and reliability of the carrier networks

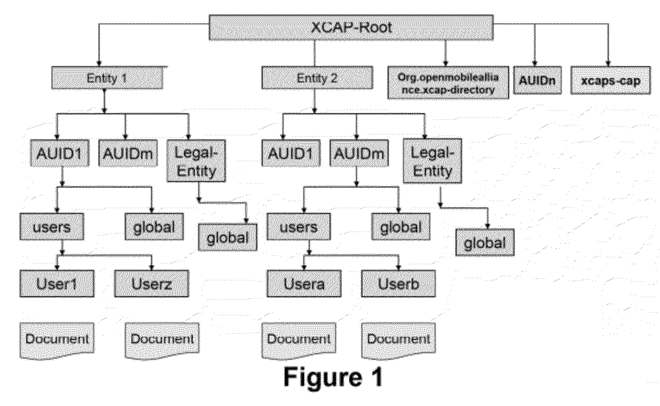

Given that an M2M service provider has several independent clients (legal entities) each of which may require privacy, or even complete privacy, of their data from other clients, the following directory scheme shown below will preferably be applied for this exemplary embodiment. In this scheme, several principles enumerated here can be observed. Each legal entity will preferably have a different tree under the XCAP root. This can allow for complete privacy and simplification of the entire XDMS operation. Each legal entity tree will preferably have one common application usage (Entity Access) applicable to the all application usages under the legal entity tree. Application usages that are common to all legal entities will preferably be defined immediately under the XCAP-root. (e.g. AUIDn in the figure below). OMA defined Application usages will preferably retain their location in the M2M directory scheme. In other words, xcap-caps AUID will preferably be located immediately beneath the XCAP root. The same preferably applies to the oma.openmpobilealliance.xcap-directory AUID, which will preferably be located immediately beneath the XCAP root. FIG. 1 shows a high level overview of the above principles

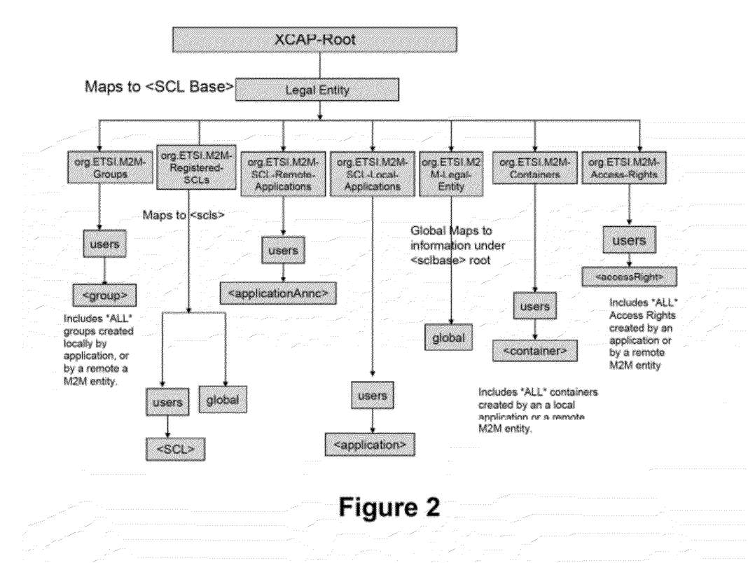

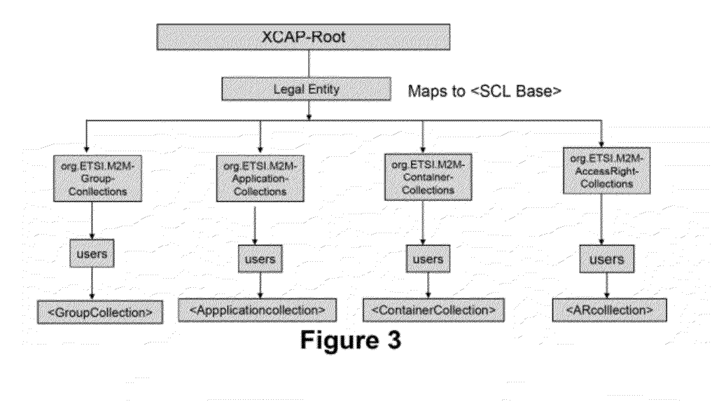

The FIGS. 2 and 3 show a proposed directory structure for the M2M resources according to an embodiment of the present invention. FIGS. 2 and 3 will be understood by those skilled in the art to be exemplary directory structures. Eleven Application Usages are identified herein for managing M2M resource. This list should not be considered to be exhaustive, but instead viewed as being sufficient for explanatory purposes. These usages are:
Access Right Application Usage defined under the legal entry tree. Although Access rights resources apply to all legal entities, permissions are specific to every legal entity and as such it is defined under the legal entity tree. This Application Usage handles the management of M2M access rights resources created under the legal entity.
Group Application Usage defined under the legal entity tree. The Group resource is specific to a legal entity and as such it is contained within the legal entity tree. This Application Usage handles the management of M2M group resources created under the legal entity.
Container Application Usage defined under the legal entity tree. The Container resource is specific to a legal entity and as such it is contained within the legal entity tree. This Application Usage handles the management of M2M container resources created under the legal entity.
The remote SCL (remote gateways/devices) Application Usage defined under the legal entity tree. This Application Usage handles the management of M2M SLCs (remote or registered SCLs) created under the legal entity.
Centreally Registered M2M Applications Application Usage defined under the legal entity tree. This Application Usage can address the management of M2M applications created under the legal entity.
Announced Applications (Remotely registered M2M Applications) Application Usage defined under the legal entity tree. This Application Usage handles the management of M2M announced applications resources created under the legal entity.
Container Collection Application Usage defined under the legal entity tree. This Application Usage handles the management of M2M container collection resources, including announced containers, created under the legal entity.
Group Collection Application Usage defined under the legal entity tree. This Application Usage handles the management of M2M group collection resources, including announced groups, created under the legal entity.
Access Rights Collection Application Usage defined under the legal entity tree. This Application Usage handles the management of M2M access rights collection resources, including announced access rights, created under the legal entity.
Application Collection Application Usage defined under the legal entity tree. This Application Usage handles the management of M2M application collection resources, including announced applications, created under the legal entity.
M2M Legal Entity Application usage defined under the legal entity tree. This Application Usage handles the management of all M2M resources created under the legal tree.

There is preferably a one to one mapping between every XCAP URI used in XDMS and HTTP URI used over the mid and mIa interfaces. The mapping is preferably maintained in the M2M Service Capability AS. Initially the XCAP root is provisioned in the M2M AS, or discovered through defined XDMS procedures. Following that, and through the application usage, the M2M Service Capability AS preferably creates the necessary XCAP URIs for storing an XML document in the XCAP directory and maintains a mapping between that XCAP URI and the equivalent HTTP URI for the XML document. Even though the directory structure in XDMS is not completely identical to the resource structure, the M2M Service Capability AS is able to recreate an identical match for the resource structure to be able to respond to requests over the mIa and mId interfaces. Typically in these cases, the stored XDMS documents will preferably include XCAP references. The M2M Service Capability AS will preferably retrieve the XDMS documents associated with these XCAP references and reconstruct the requested information. The Application Usages for the various resources will elaborate these cases in more details.

The above enumerated usage cases will now be discussed in more detail. These details should be understood to be explanatory in nature, and should not be considered as limiting of the scope of the present invention.

The M2M Legal Entity Application Usage is an application that controls access to other resources under the legal entity tree and also stores information pertinent to the legal entity tree. M2M Legal Entity typically have only one global tree located beneath the AUID tree allocated to the M2M Legal Entity resource. The AUID will preferably be “org.ETSI.M2M-Legal-Entity”

The MIME type for the various XDM documents for the M2M Legal-Entity will preferably be as follows: accessRights document, applications document, accessPermission document, subscriptions document, groups document, containers document and attributes document, all under global tree, will preferably be as defined in ETSI TS 102 690. The default namespace will preferably be “urn:etsi:xml:xdm:M2M-Legal-Entity”.

The M2M Legal Entity XDM documents will preferably conform to the following XML schemas: accessRights document under global tree will preferably conform to XML schema as defined in ETSI TS 102 690 with the exception that XCAP references will preferably be used where applicable, to reference documents stored under the Access-Right resources; accessPermission document under global tree will preferably conform to XML schema as defined in ETSI TS 102 690 with the exception that XCAP references will preferably be used to reference documents stored under the Access-Right resources; applications document under global tree will preferably conform to XML schema as defined in ETSI TS 102 690 with the exception that XCAP references will preferably be used where applicable, to reference documents stored under the Application Collection resources; groups document under global tree will preferably conform to XML schema as defined in ETSI TS 102 690 with the exception that XCAP references will preferably be used where applicable, to reference documents stored under the Group Collection resources; containers document under global tree will preferably conform to XML schema as defined in ETSI TS 102 690 with the exception that XCAP references will preferably be used where applicable, to reference documents stored under the Container Collections resources; subscriptions document under global tree will preferably conform to XML schema as defined in ETSI TS 102 690; and attributes document under global tree will preferably conform to XML schema as defined in ETSI TS 102 690 (with the exception of accessRightID)

The request originator will preferably be extracted from the X-3GPP-Asserted-Identity HTTP header and will preferably be used by the XDMS for validating access rights for every requested operation on any resource under the legal entity tree before the operation is accepted.

The semantics for the data is preferably in accordance with definitions in the relevant section of ETSI TS 102 690.

There will preferably not be any instance of this document in the user's tree.

The XDMS server will preferably authorize requests for all operations on all XDM documents located under the entire Legal Entity tree using the accessPermission document located under the global tree for that purpose.

This Application Usage defines seven global documents. The first document preferably includes the attributes for the M2M Legal Entity (except AccessRightID). The well-known name of the document is attributes. The) (NIL schema for this document is preferably defined in accordance with the relevant section of ETSI TS 102 690. The attributes document will preferably be addressed using the global directory document selector “/Attributes/, i.e. the document selector to the XDM attributes document will preferably be “[auid]/global/Attributes/attributes”.

The second document preferably includes the accessPermission for all XDM documents under the Legal Entity tree. The well-known name of the document is accessPermission. The XML schema for this document is preferably defined in accordance with the relevant section of ETSI TS 102 690. The accessPermission document will preferably be addressed using the global directory document selector “/Access-Permission/, i.e. the document selector to the XDM attributes document will preferably be [auid]/global/Access-Permission/accessPermission”.

The third well-known name of the document is applications. The XML schema for this document is preferably defined in accordance with the relevant section of ETSI TS 102 690. The applications document will preferably be addressed using the global directory document selector “/Applications/, i.e. the document selector to the XDM applications document will preferably be “[auid]/global/Applications/applications”. There preferably is only a single instance for all these documents.

The fourth well-known name of the document is groups. The XML schema for this document is preferably defined in accordance with the relevant section of ETSI TS 102 690. The groups document will preferably be addressed using the global directory document selector “/Groups/, i.e. the document selector to the XDM applications document will preferably be “[auid]/global/Groups/groups”. There preferably is only a single instance for all these documents.

The fifth well-known name of the document is containers. The XML schema for this document is preferably defined in accordance with the relevant section of ETSI TS 102 690. The containers document will preferably be addressed using the global directory document selector “/Containers/, i.e. the document selector to the XDM applications document will preferably be “[auid]/global/Containers/containers”. There preferably is only a single instance for all these documents.

The sixth well-known name of the document is accessRights. The XML schema for this document is preferably defined in accordance with the relevant section of ETSI TS 102 690. The accessRights document will preferably be addressed using the global directory document selector “/AccessRights/, i.e. the document selector to the XDM applications document will preferably be “[auid]/global/AccessRights/accessRights”. There preferably is only a single instance for all these documents.

The seventh well-known name of the document is subscriptions. The XML schema for this document is preferably defined in accordance with the relevant section of ETSI TS 102 690. The applications document will preferably be addressed using the global directory document selector “/Subscriptions/, i.e. the document selector to the XDM subscriptions document will preferably be “[auid]/global/Subscriptions/subscriptions”. There preferably is only a single instance for all these documents. There preferably is only a single instance for all these documents.

The Access Right Application Usage preferably allows an M2M entity to create/modify/delete Access Right resources. Each Access Right resource that is created will preferably be allocated a unique identity that is under the users' tree beneath the AUID tree allocated to the Access Rights resources. The M2MSC acting as an XDM agent will preferably be able to select a specific Access Right resource identified by its unique identity and bind it to any M2M resource for access right purposes. The binding will preferably be achieved by referencing the XCAP document matching the unique identity for the selected Access Right resource.

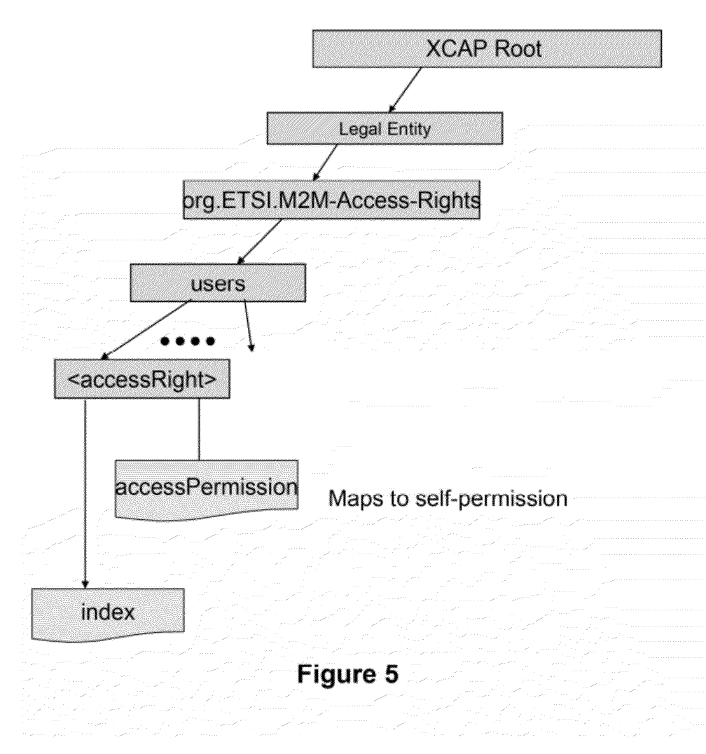

The Application Unique ID will preferably be referenced as “org.ETSI.M2M-Access-Rights” in the context of FIG. 5. The MIME type for the various XDM documents for the management of the Access Right resource will preferably be as follows: the index document, subscriptions document, permissions document, accessPermission document and accessStatus documents are each preferably, per the XUI, under the users' tree and will preferably be defined in accordance with the relevant sections of ETSI TS 102 690. The default namespace will preferably be “urn:etsi:xml:xdm:M2M-Access-Rights”

The Access Right resource XDM documents will preferably conform to the following XML schemas: index document, accessStatus document, subscriptions document, permissions document, each under users' tree will preferably conform to XML schema defined in accordance with the relevant section of ETSI TS 102 690. The accessPermission document under users' tree will preferably conform to XML schema as defined in accordance with the relevant sections of ETSI TS 102 690 with the exception that XCAP references will preferably be used where applicable, to reference documents stored under the Access-Right resources.

In addition to conforming to the XML schema, the XDMS will preferably enforce the syntax allocated to the permission element. The XDMS will preferably ensure that each identity allocated to an Access Right resource under the users' tree is unique. The request originator can be extracted from the X-3GPP-Asserted-Identity HTTP header and will preferably be used by the XDMS for validating access rights for the requested operation before the operation is accepted.

The semantics for the data is preferably defined in accordance with the relevant section of ETSI TS 102 690.

There are two options to store Access-Right XDM document. In option 1, illustrated in FIG. 5, there will preferably be only two Right Access resource XDM documents per XUI. The well-known name of the main Right Access document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except accessPermission which is identical in both options)

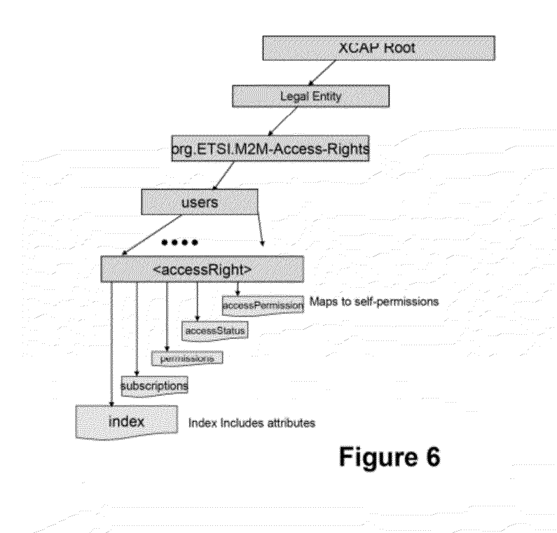

In option two (shown in FIG. 6), there will preferably be five well-known documents. The well-known name of the main Right Access resource XDM document will preferably be “index”. The document selector to access the “index” XDM document will preferably be “[auid]/users/[xui]/index”. The second well known document name is “subscriptions”. The document selector to access the subscriptions XDM document will preferably be “[auid]/users/[xui]/subscriptions”. The third well known document is “permissions”. The document selector to access the permission XDM document will preferably be “[auid]/users/[xui]/permissions” The fourth well known document is “accessPermission”. The document selector to access the accessPermission XDM document will preferably be “[auid]/users/[xui]/accessPermission”. Finally, the last well known document is “accessStatus”. The document selector to access the accessStatus XDM document will preferably be “[auid]/users/[xui]/accesStatus”.

For either option there is preferably only a single instance for every document

The XDMS server will preferably authorize requests for all operations on XDM documents located under the XUI tree using the accessPermission document located under the same XUI tree for that purpose.

The Group Application Usage allows an M2M entity to be able to create/modify/delete a Group resource.

Every Group resource that is created preferably is allocated a unique identity that is under the users' tree beneath the AUID tree allocated to the Group resource. The XDMS will also preferably ensure that members allocated to a group are uniquely identified.

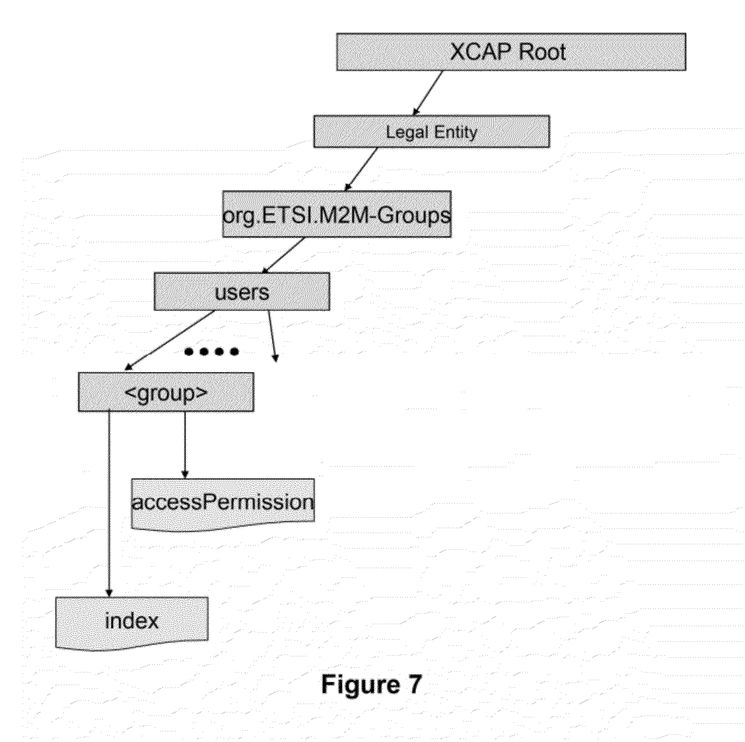

The application unique identifier for the case illustrated in FIG. 7 will preferably be “org.ETSI.M2M-Groups”

The MIME type for the various XDM documents for the Group resource will preferably be as follows: index document, accessStatus document, accessPermission document, subscriptions document, and members document are each, per XUI, under users' tree and will preferably be defined in accordance with the relevant sections of ETSI TS 102 690 The default namespace will preferably be “urn:etsi:xml:xdm:M2M-Groups”

The Group Resource XDM documents will preferably conform to the following XML schemas: index document, accessStatus document, subscriptions document, and members document each under users' tree will preferably conform to XML schema as defined in accordance with ETSI TS 102 690; the accessPermission document under users' tree will preferably conform to XML schema as defined in accordance with the relevant sections of ETSI TS 102 690 with the exception that XCAP references will preferably be used where applicable, to reference documents stored under the Access-Right resources.

In addition to conforming to the XML schema, the XDMS will preferably enforce the syntax allocated to member ids and will preferably ensure the uniqueness of member ids in the group. The XDMS will preferably also ensure that every identity allocated to a Group resource is unique. The request originator can be extracted from the X-3GPP-Asserted-Identity HTTP header and will preferably be used by the XDMS for validating access rights for the requested operation before the operation is accepted.

The semantics for the data is preferably defined in accordance with the relevant section of ETSI TS 102 690.

There are two naming convention options for storing Group XDM documents. In option 1, as illustrated in FIG. 7, there will preferably be only two Group resource XDM documents per XUI. The well-known name of the main Group resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

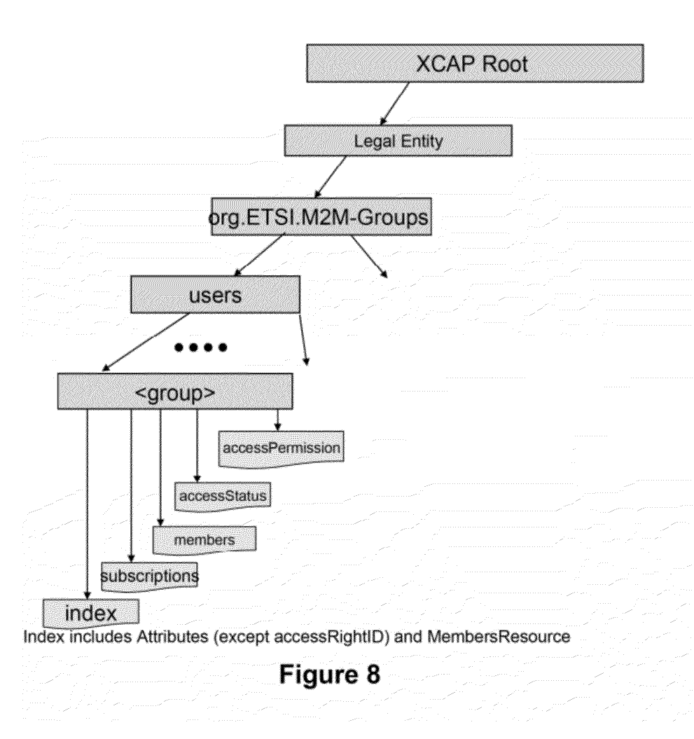

In option two (shown in FIG. 8), there will preferably be five well-known documents. The well-known name of the main Group resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well known document is “accessPermission”. The document selector to access the accessPermission XDM document will preferably be “[auid]/users/[xui]/accessPermission”. The fourth well known document is “accessSstatus”. The document selector to access the access-status XDM document will preferably be “[auid]/users/[xui]/accessSstatus”. Finally, the last well known document is “members”. The document selector to access the members XDM document will preferably be “[auid]/users/[xui]/members”.

For either option there is preferably only a single instance for every document.

The XDMS server will preferably authorize requests for all operations on XDM documents located under the XUI tree using the accessPermission document under the same XUI tree for that purpose.

The Registered SCL Application Usage allows an M2M entity to be able to create/modify/delete a Remote SCL resources registered locally. Every Remote SCL resource that is created will preferably be allocated a unique identity and will preferably be located below the users' tree located beneath the AUID tree allocated to Remote SCL resources.

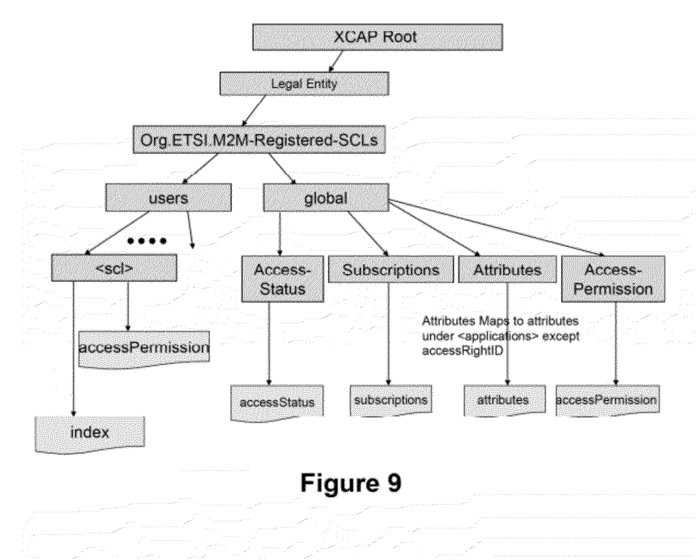

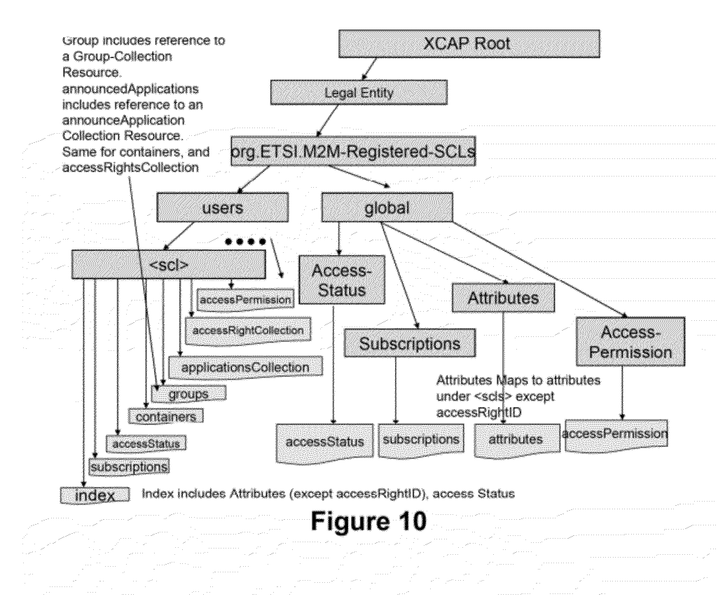

The AUID for the usage cases associated with FIGS. 9 and 10 will preferably be “org.ETSI.M2M-Registered-SCLs”. The MIME type for the various XDM documents for the Registered SCL resource will preferably be as follows:
index document under users' tree, per XUI, will preferably be as defined in accordance with ETSI TS 102 690 (excluding AccessRightID)
containers document under users' tree, per XUI, will preferably be defined in accordance with ETSI TS 102 690 with the exception that XCAP references will preferably be used, where applicable, to reference documents stored under the Container Collection resources
accessStatus document under both users' tree and global tree will preferably be as defined in accordance with ETSI TS 102 690
accessPermission document under both users' tree, per XUI, and global tree will preferably be as defined in accordance with ETSI TS 102 690 with the exception that XCAP references will preferably be used, where applicable, to reference documents stored under the Access-Right resources
subscriptions document under both users' tree, per XUI, and global tree will preferably be as defined in ETSI TS 102 690
groups document under users' tree, per XUI, will preferably be as defined in accordance with ETSI 102 690 with the exception that XCAP references will preferably be used, where applicable, to reference documents stored under the Group Collection resources
applicationsCollection document under users' tree, per XUI, will preferably be as defined in accordance with ETSI 102 690 with the exception that XCAP references will preferably be used, where applicable, to reference documents stored under the Application Collection resources
accessRightCollection document under users' tree, per XUI, will preferably be as defined in accordance with ETSI 102 690 with the exception that XCAP references will preferably be used, where applicable, to reference documents stored under the Access-Rights Collection resources
attribute document under global tree will preferably be as defined in accordance with ETSI TS 102 690 (excluding AccessRightID)

The default namespace for these exemplary embodiments will preferably be “urn:etsi:xml:xdm:M2M-Access-Rights”. The Registered SCL XDM documents will preferably conform to the following XML schemas:
index document under users' tree will preferably conform to XML schema as defined in accordance with ETSI TS 102 690 (excluding AccessRightID)
accessStatus document under both users' tree and global tree will preferably conform to XML schema as defined in accordance with ETSI TS 102 690
accessPermission document under both users' tree and global tree will preferably conform to XML schema as defined in accordance with ETSI TS 102 690 with the exception that XCAP references will preferably be used where applicable, to reference documents stored under the Access-Rights resources
containers document under users' tree will preferably conform to XML schema as defined in accordance with ETSI TS 102 690 with the exception that XCAP references will preferably be used, where applicable, to reference documents stored under the Container Collection resources
subscriptions document under users' tree and global tree will preferably conform to XML schema as defined in accordance with ETSI TS 102 690
groups document under users' tree will preferably conform to XML schema as defined in accordance with ETSI 102 690 X with the exception that XCAP references will preferably be used, where applicable, to reference documents stored under the Group Collection resources
applicationsColletcion document under users' tree will preferably conform to XML schema as defined in accordance with ETSI 102 690 with the exception that XCAP references will preferably be used, where applicable. to reference documents stored under the Application Collection Resources
accessRightCollection document under users' tree will preferably conform to XML schema as defined in accordance with ETSI 102 690 with the exception that XCAP references will preferably be used, where applicable, to reference documents stored under the Access-Right Collection Resources
attributes document under global tree will preferably conform to XML schema as defined in accordance with ETSI 102 690 (excluding AccessRightID).

In addition to conforming to the XML schema, the XDMS will preferably ensure that every identity allocated to a Registered SCL resource is unique. The request originator can be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

There are two naming convention options for storing Registered SCL XDM documents. In option 1, illustrated in FIG. 9, there will preferably be only two Registered SCL resource XDM documents per XUI. The well-known name of the main Registered SCL resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown in the FIG. 10), there will preferably be eight well-known documents. The well-known name of the main Registered SCL resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well know document is “containers”. The document selector to access the containers XDM document will preferably be “[auid]/users/[xui]/containers”. The fourth well known document is “accessPermission”. The document selector to access the accessPermission XDM document will preferably be “[auid]/users/[xui]/accessPermission”. The fifth well known document is “groups”. The document selector to access the groups XDM document will preferably be “[auid]/users/[xui]/groups”. The sixth well known document is “accessRightCollection”. The document selector to access the accessRightsCollection XDM document will preferably be “[auid]/users/[xui]/accessRightCollection”. The seventh well known document is “accessStatus”. The document selector to access the accessStatus XDM document will preferably be “[auid]/users/[xui]/accessStatus”. Finally, the last well known document is “applicationsCollection”. The document selector to access the applicationsCollection XDM document will preferably be “[auid]/users/[xui]/applicationsCollection”. For either option there is preferably only a single instance for every document.

The XDMS server will preferably authorize requests for all operations on XDM documents located under the XUI tree using the accessPermission document under the same XUI tree for that purpose. The XDMS server will preferably authorize requests for all operations on XDM documents located under the global tree using the accessPermission document located under the global tree for that purpose.

This Application Usage defines four global documents. The first document has the access status for the Registered SCL resources. The well-known name for the document is accessStatus. The XML schema for this document is preferably defined in accordance with the relevant sections of ETSI TS 102 690. The accessStatus document will preferably be addressed using the global directory document selector “/Access-Status/, i.e. the document selector to the XDM access-status document will preferably be “[auid]/global/AcessStatus/accessStatus”. The second document includes the status of active subscriptions for the Registered SCL resources. The well-known name of the document is subscriptions. The XML schema for this document is preferably defined in accordance with the relevant sections of ETSI TS 102 690. The subscriptions document will preferably be addressed using the global directory document selector “/Subscriptions/, i.e. the document selector to the XDM subscription-status document will preferably be “[auid]/global/Subscriptions/subscriptions”. The third document includes the attributes for the Registered SCL resources. The well-known name of the document is attributes. The XML schema for this document is preferably defined in accordance with the relevant sections of ETSI TS 102 690. The attributes document will preferably be addressed using the global directory document selector “/Attributes/, i.e. the document selector to the XDM attributes document will preferably be “[auid]/global/Attributes/attributes”. The fourth and last document includes the accessPermission for XDM documents in the global tree. The well-known name of the document is accessPermission. The XML schema for this document is preferably defined in accordance with the relevant sections of ETSI TS 102 690. The accessPermission document will preferably be addressed using the global directory document selector “/Access-Permission/, i.e. the document selector to the XDM attributes document will preferably be “[auid]/global/Access-Permission/accessPermission”.

There is preferably only a single instance for all these documents.

The M2M SCL Announced Applications Application Usage allows an M2M entity to be able to Create/Modify/Delete/Read an M2M SCL Application Announced resource. These are applications registered remotely in remote SCLs and who announces such a registration. Every M2M SCL Announced Applications resource that is created will preferably be allocated a unique identity and will preferably be located under the users' tree located beneath the AUID tree allocated to the M2M SCL Announced Applications resources.

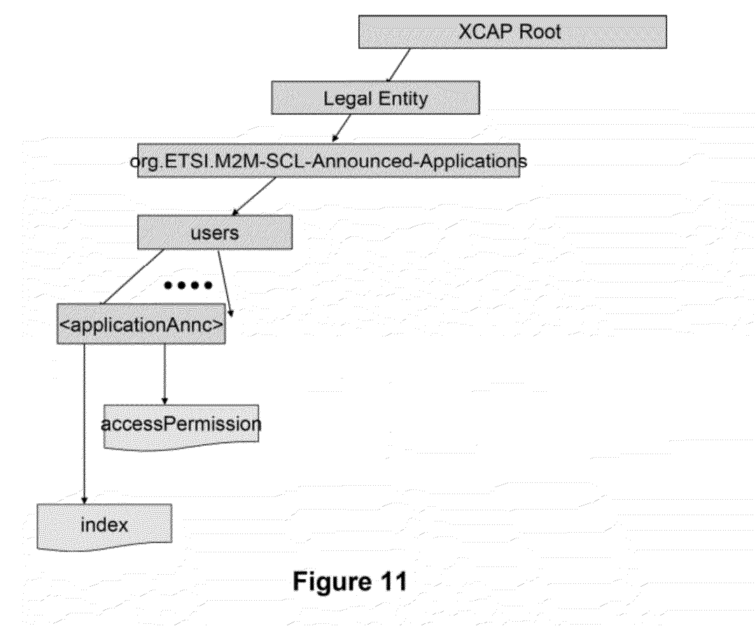

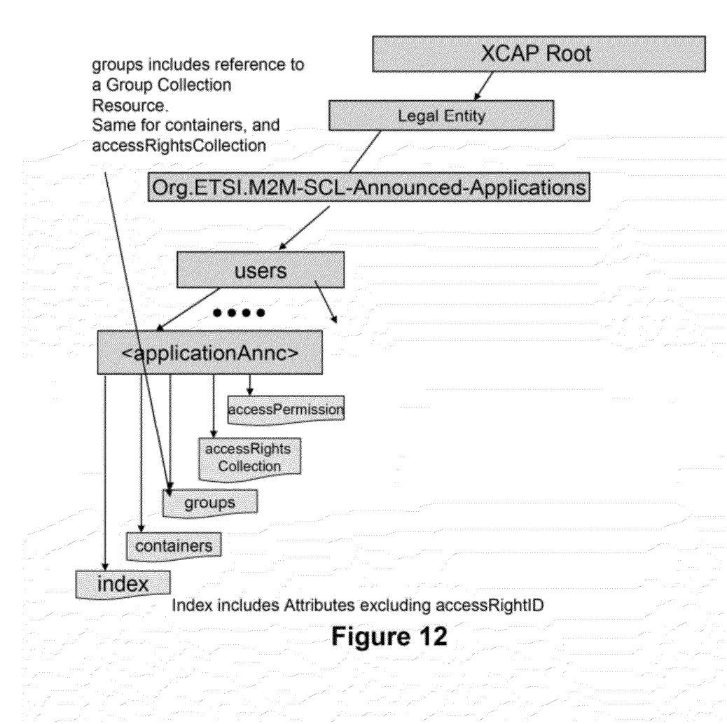

The AUID for the usage case of FIGS. 11 and 12 will preferably be “org.ETSI.M2M-SCL-Announced-Applications”. The MIME type for the various XDM documents for the M2M SCL Announced Applications resource will preferably be as follows: index document, containers document, accessPermission document, groups document, and accessRightsCollection document are each under users' tree, per XUI, will preferably be defined in accordance with the relevant sections of ETSI TS 102 690

The default namespace WILL PREFERABLY be “urn:etsi:xml:xdm:M2M-SCL-Announced-Applications”

The M2M SCL Announced Applications XDM documents will preferably conform to the following XML schemas:
index document under users' tree will preferably conform to XML schema as defined in accordance with the relevant sections of ETSI TS 102 690 (excluding AccessRightID)
accessPermission document under users' tree will preferably conform to XML schema as defined in accordance with the relevant sections of ETSI TS 102 690 with the exception that XCAP references will preferably be used where applicable, to reference documents stored under the Access-Rights resources
containers document under users' tree will preferably conform to XML schema as defined in accordance with the relevant sections of ETSI TS 102 690 with the exception that XCAP references will preferably be used, where applicable, to reference documents stored under the Container Collection resources
groups document under users' tree will preferably conform to XML schema as defined in accordance with the relevant sections of ETSI TS 102 690 with the exception that XCAP references will preferably be used, where applicable, to reference documents stored under the Group Collection resources
accessRightsCollection document under users' tree will preferably conform to XML schema as defined in accordance with the relevant sections of ETSI TS 102 690 with the exception that XCAP references will preferably be used, where applicable, to reference documents stored under the Access-Rights Collection resources

In addition to conforming to the XML schema, the XDMS will preferably ensure that every identity allocated to a M2M SCL Announced Applications resource is unique. The request originator will preferably be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

There are two options for storing SLC Announced Applications XDM documents. In option 1 as shown in FIG. 11, there will preferably be only two M2M SCL Announced Applications resource XDM documents per XUI. The well-known name of the main M2M SCL Announced Applications resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown in FIG. 12), there will preferably be five well-known documents. The well-known name of the main M2M SCL Announced Applications resource XDM document will preferably be “index”. The document selector to access the “index” XDM document will preferably be “[auid]/users/[xui]/index”. The second well known document is “groups”. The document selector to access the groups XDM document will preferably be “[auid]/users/[xui]/groups”. The third well know document is “containers”. The document selector to access the containers XDM document will preferably be “[auid]/users/[xui]/containers”. The “fourth well known document is “accessRightsCollection”. The document selector to access the accessRightsCollection XDM document will preferably be “[auid]/users/[xui]/accessRightsCollection”. Finally, the last well known document is “accessPermission”. The document selector to access the accessPermission XDM document will preferably be “[auid]/users/[xui]/accessPermission”. For either option there is only a single instance for every document. The XDMS server will preferably authorize requests for all operations on XDM documents located under the XUI tree using the accessPermission document under the same XUI tree for that purpose.

The M2M SCL Local Applications Application Usage allows an M2M entity to be able to Create/Modify/Delete/Read an M2M Local SCL Application resource that is registered locally in the SCL. Every M2M Local SCL Applications resource that is created will preferably be allocated a unique identity and will preferably be located under the users' tree beneath the AUID tree allocated to the M2M SCL Local Applications resources. Applications managed under this resource are applications that are registered locally.

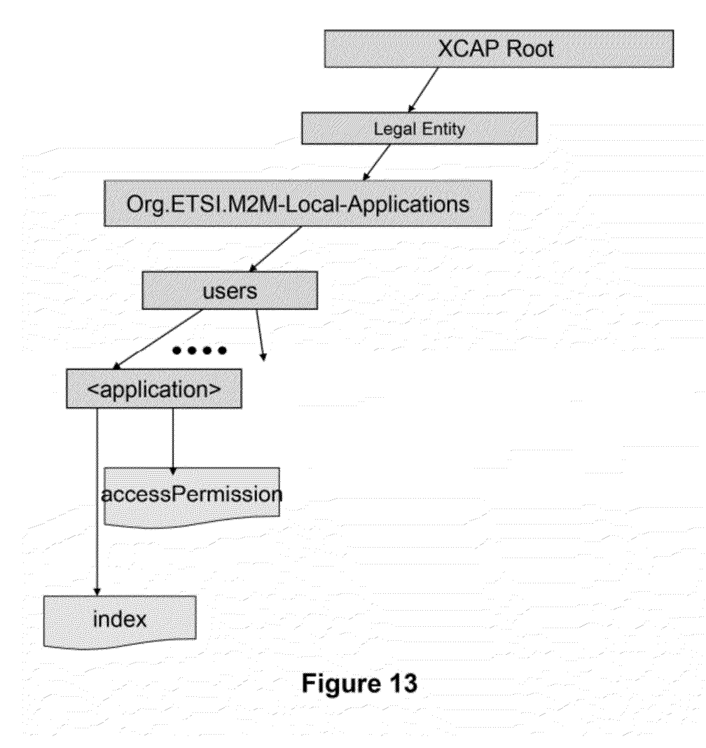

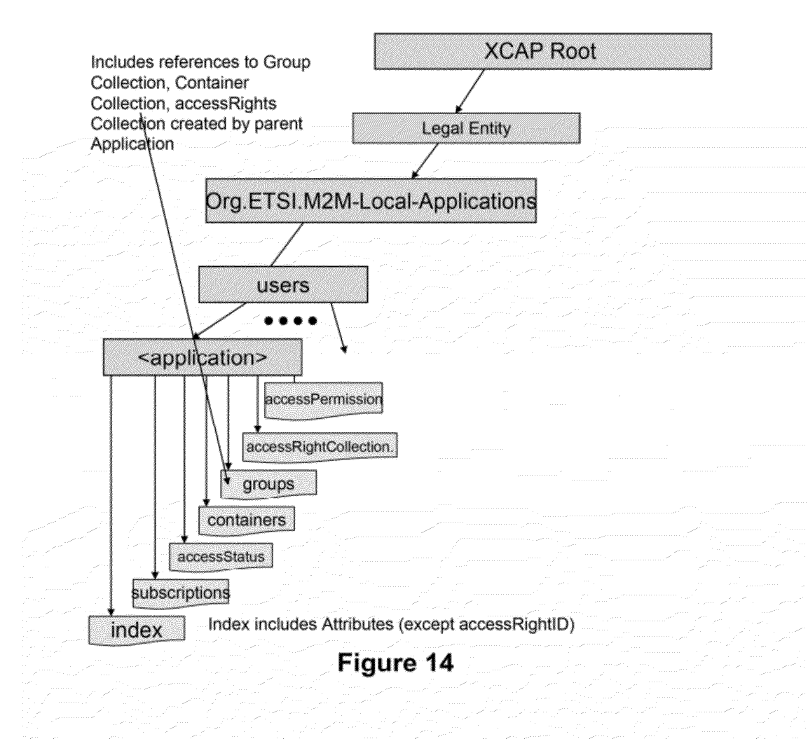

The AUID for the usage cases of FIGS. 13 and 14 will preferably be “org.ETSI.M2M-Local-Applications”. The MIME type for the various XDM documents for the M2M SCL Local Applications resource will preferably be as follows:
index document, under users' tree, per XUI, will preferably be defined in accordance with the relevant sections of ETSI TS 102 690 (excluding AccessRightID)
accessStatus document under users' tree, per XUI, will preferably be defined in accordance with the relevant sections of ETSI TS 102 690
accessRightCollection document under users' tree, per XUI, will preferably be defined in accordance with the relevant sections of ETSI TS 102 690 with the exception that XCAP references will preferably be used, where applicable, to reference documents stored under the Access Right Collection resources
subscriptions document under users' tree, per XUI, will preferably be defined in accordance with the relevant sections of ETSI TS 102 690
groups document under users' tree, per XUI, will preferably be defined in accordance with relevant section in ETSI TS 102 690 with the exception that XCAP references will preferably be used, where applicable, to reference documents stored under the Group Collection resources
containers document under users' tree, per XUI, will preferably be defined in accordance with relevant section in ETSI TS 102 690 with the exception that XCAP references will preferably be used, where applicable, to reference documents stored under the Container Collection resources
accessPermission document under users' tree, per XUI, will be defined in accordance with relevant section in ETSI TS 102 690 with the exception that XCAP references will preferably be used, where applicable, to reference documents stored under the Access Rights resources

The default namespace will preferably be “urn:etsi:xml:xdm:M2M-SCL-Local-Applications”. The M2M SCL Local Applications XDM documents will preferably conform to the following XML schemas:
index document under users' tree, per XUI, will preferably conform to XML schema as defined in ETSI TS 102 690 (except AccessRightID)
accessStatus document under users' tree will preferably conform to XML schema as defined in ETSI TS 102 690
accessPermission document under users' tree, per XUI, will preferably conform to XML schema as defined in ETSI TS 102 690 with the exception that that XCAP references will preferably be used where applicable, to reference documents stored under the Access-Rights resources
containers document under users' tree, per XUI, will preferably conform to XML schema as defined in ETSI TS 102 690 with the exception that that XCAP references will preferably be used where applicable, to reference documents stored under the Container Collections resources
subscriptions document under users' tree, per XUI, and global tree will preferably conform to XML schema as defined in ETSI TS 102 690
groups document under users' tree, per XUI, will preferably conform to XML schema as described in ETSI TS 102 690 with the exception that that XCAP references will preferably be used where applicable, to reference documents stored under the Group Collection resources
accessRightCollection document under users' tree, per XUI, will preferably conform to XML schema as described in ETSI TS 102 690 with the exception that that XCAP references will preferably be used where applicable, to reference documents stored under the Access-Rights Collection resources

In addition to conforming to the XML schema, the XDMS will preferably ensure that every identity allocated to a M2M SCL Local Application resource is unique. The request originator will preferably be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

There are two naming convention options for storing Local Application XDM documents. In option 1 as illustrated in 13, there will preferably be only two M2M SCL Local Applications resource XDM documents per XUI. The well-known name of the main M2M SCL Local Applications resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown in FIG. 14), there will preferably be seven well-known documents. The well-known name of the main M2M SCL Local Applications resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well know document is “containers”. The document selector to access the containers XDM document will preferably be “[auid]/users/[xui]/containers”. The fourth well know document is “groups”. The document selector to access the groups XDM document will preferably be “[auid]/users/[xui]/groups”. The fifth well know document is “accessRightCollection”. The document selector to access the accessRightCollection XDM document will preferably be “[auid]/users/[xui]/accessRightCollection”. The sixth well know document is “accessStatus”. The document selector to access the accessStatus XDM document will preferably be “[auid]/users/[xui]/accessStatus”. Finally, the last well known document is “accessPermission”. The document selector to access the accessPermission XDM document will preferably be “[auid]/users/[xui]/accessPermission”.

For either option there preferably is only a single instance for every document.

The XDMS server will preferably authorize requests for all operations on XDM documents located under the XUI tree using the accessPermission document under the same XUI tree for that purpose.

The Container Application Usage allows an M2M entity to be able to create/modify/delete a Container resource.

Each Container resource that is created will preferably be allocated a unique identity that is under the users' tree beneath the AUID tree allocated to the Container resource. The AUID will preferably be “org.ETSI.M2M-Containers”

The MIME type for the various XDM documents for the Container resource will preferably be as follows: index document, accessStatus document, accessPermission document, subscriptions document, and contentInstances document are each under users' tree, per XUI, will preferably be defined in accordance with ETSI TS 102 690.

The default namespace will preferably be “urn:etsi:xml:xdm:M2M-Containers. The Container Resource XDM documents will preferably conform to the following XMsL schemas:
index document under users' tree will preferably conform to XML schema defined in accordance with ETSI TS 102 690 (excluding AccesssRightID)
accessStatus document under users' tree will preferably conform to XML schema defined in accordance with ETSI TS 102 690
accessPermission document under users' tree will preferably conform to XML schema defined in accordance with ETSI TS 102 690 with the exception that XCAP references will preferably be used where applicable, to reference documents stored under the Access-Rights resources
subscriptions document under users' tree will preferably conform to XML schema defined in accordance with ETSI TS 102 690
contentInstances document under users tree will preferably conform to XML schema be defined in accordance with ETIS 102 690

In addition to conforming to the XML schema, the XDMS will preferably also ensure that every identity allocated to a Container resource is unique. The request originator will preferably be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

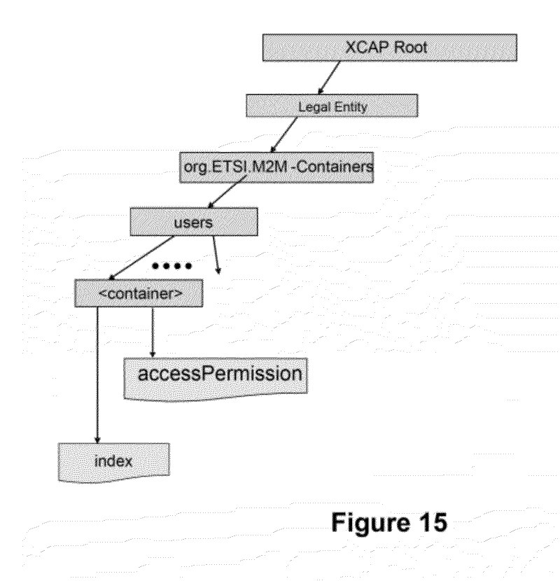

There are two options for storing Container resource XDM documents. In option 1, as illustrated in FIG. 15, there will preferably be only two Container resource XDM documents per XUI. The well-known name of the main Container resource document will preferably be “index”. The document selector to access the “index” XDM document will preferably be “[auid]/users/[xui]/index”. The second well known document is “accessPermission”. The document selector to access the access-rights XDM document will preferably be “[auid]/users/[xui]/accessPermission”. The index document encompasses all the information in option 2 below (except the accessPermission which is identical in both options)

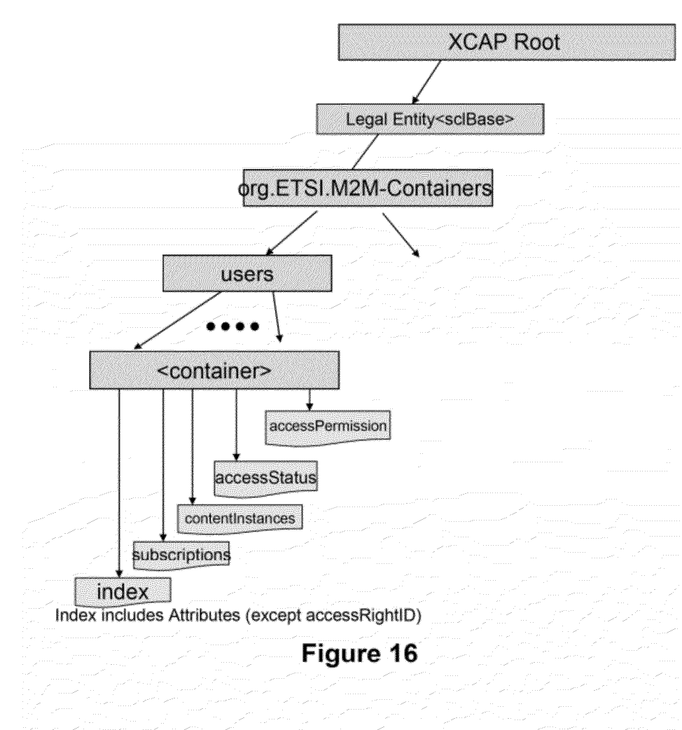

In option two (shown FIG. 16), there will preferably be five well-known documents. The well-known name of the main Container resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well known document is “accessPerrmission”. The document selector to access the accessPermission XDM document will preferably be “[auid]/users/[xui]/accessPermission”. The fourth well known document is “accessStatus”. The document selector to access the accessStatus XDM document will preferably be “[auid]/users/[xui]/accessStatus”. Finally, the last well known document is “contentInstances”. The document selector to access the contentInstances XDM document will preferably be “[auid]/users/[xui]/contentInstances”. For either option there is preferably only a single instance for every document

The XDMS server will preferably authorize requests for all operations on XDM documents located under the XUI tree using the accessPermission document under the same XUI tree for that purpose. The Group Collection Application Usage allows an M2M entity to be able to create/modify/delete a collection of Group resources. Each Group Collection resource that is created will preferably be allocated a unique identity that is under the users' tree beneath the AUID tree allocated to the Group Collection resource.

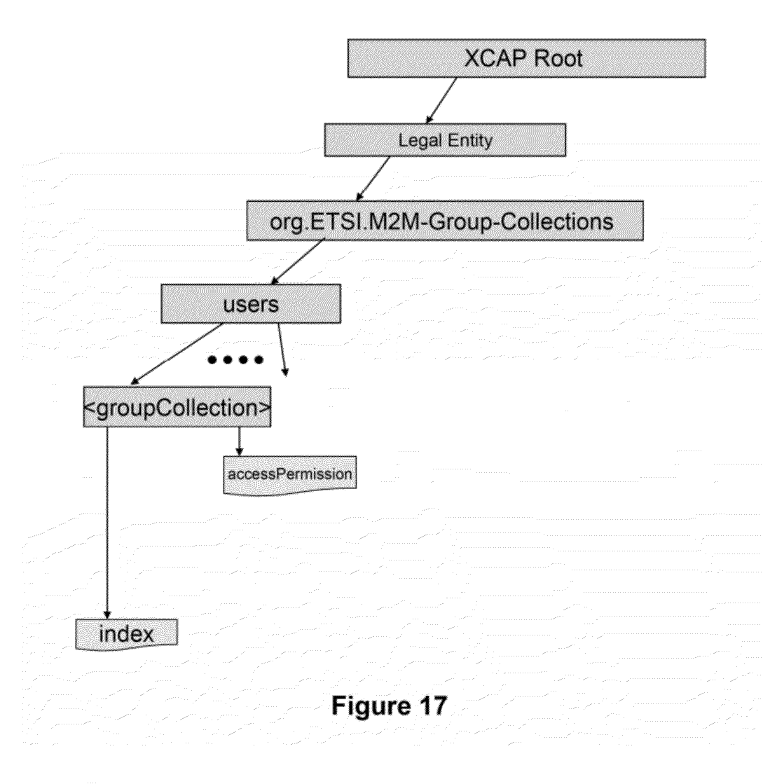

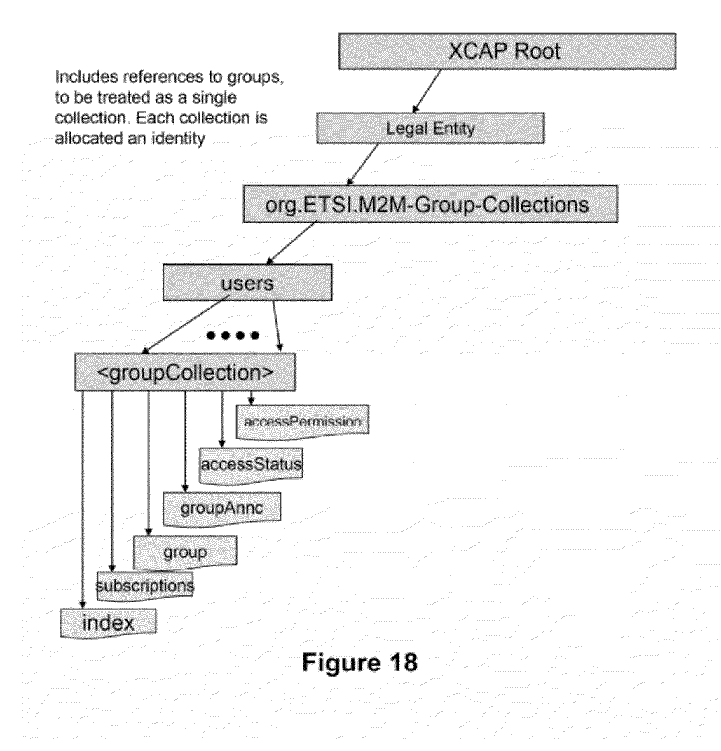

The AUID for FIGS. 17 and 18 will preferably be “org.ETSI.M2M-Group-Collections”. The MIME type for the various XDM documents for the Group Collection resource will preferably be as follows: index document, accessStatus document, accessPermission document subscriptions document, group document and groupAnnc document are each under the users' tree, per XUI, will preferably be defined in accordance with ETSI TS 102 690

The default namespace WILL PREFERABLY be “urn:etsi:xml:xdm:M2M-Group-Collections”. The Group Collection Resource XDM documents will preferably conform to the following XML schemas: index document, accessStatus document, subscriptions document, and groupAnnc document under users' tree will preferably conform to XML schema defined in accordance with ETSI TS 102 690,whereas the group document will preferably conform to XML schema defined in accordance with ETSI TS 102 690 with the exception that XCAP references will preferably be used where applicable, to reference documents stored under the Groups resources. The accessPermission document under users' tree will preferably conform to XML schema defined in accordance with ETSI TS 102 690 with the exception that XCAP references will preferably be used where applicable, to reference documents stored under the Access-Rights resources. In addition to conforming to the XML schema, the XDMS will preferably ensure that every identity allocated to a Group Collection resource is unique. The request originator will preferably be extracted from the X-3GPP-Asserted-Identity HTTP header and will preferably be used by the XDMS for validating access rights for the requested operation before the operation is accepted.

The semantics for the data is preferably defined in accordance with the relevant sections of ETSI TS 102 690.

There are two options for storing Group Collections XDM documents. In option 1, as illustrated in FIG. 17, there will preferably be only two Group Collection resource XDM documents per XUI. The well-known name of the main Group Collection resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown FIG. 18), there will preferably be six well-known documents. The well-known name of the main Group Collection resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well known document is “accessPermission”. The document selector to access the accessPermission XDM document will preferably be “[auid]/users/[xui]/Permission”. The fourth well known document is “group”. The document selector to access the group XDM document will preferably be “[auid]/users/[xui]/group”. The fifth well known document is “groupAnnc”. The document selector to access the groupAnnc XDM document will preferably be “[auid]/users/[xui]/groupAnnc”. Finally, the last well known document is “accessStatus”. The document selector to access the accessStatus XDM document will preferably be “[auid]/users/[xui]/accessStatus”. For either option there is preferably only a single instance for every document. The XDMS server will preferably authorize requests for all operations on XDM documents located under the XUI tree using the accessPermission document under the same XUI tree for that purpose.

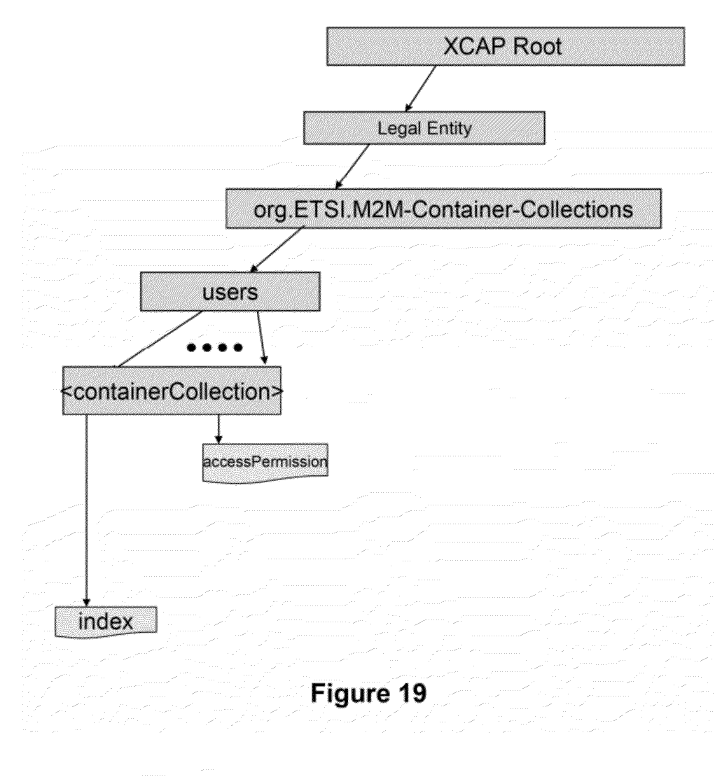

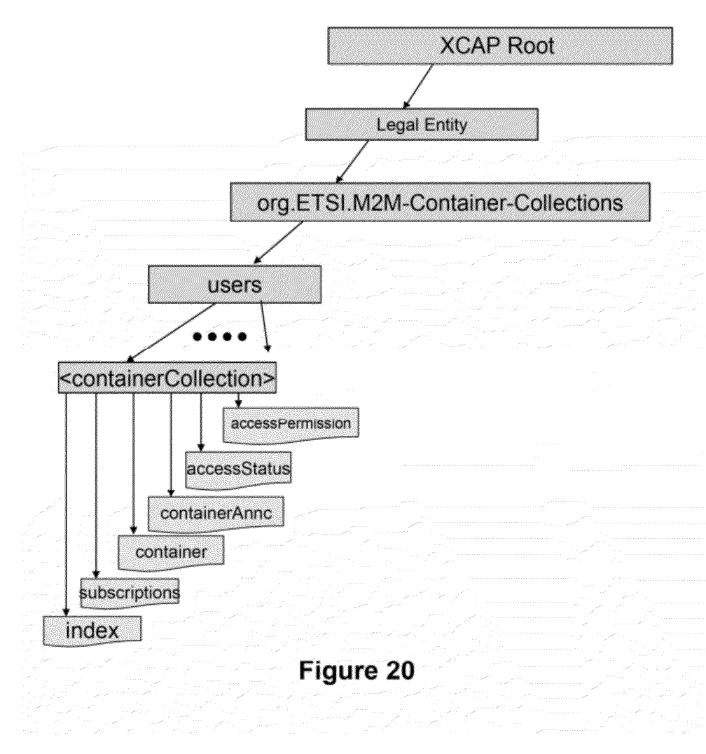

The Container Collection Application Usage allows an M2M entity to be able to create/modify/delete a collection of Container resources. Each Container Collection resource that is created will preferably be allocated a unique identity that is under the users' tree beneath the AUID tree allocated to the Container Collection resource. The AUID for the examples of FIGS. 19 and 20 will preferably be “org.ETSI.M2M-Container-Collections”

The MIME type for the various XDM documents for the Container Collection resource will preferably be as follows: index document, accessStatus document, accessPermission document, subscriptions document, container document, and containerAnnc document, each under users' tree, per XUI, will preferably be defined in accordance with ETSI TS 102 690. The default namespace WILL PREFERABLY be “urn:etsi:xml:xdm:M2M-Cntainer-Collections”.

The Container Collection resource XDM documents will preferably conform to the following XML schemas: index document, accessStatus document, subscriptions document, and containerAnnc document under users' tree will preferably conform to XML schema defined in accordance with ETSI TS 102 690, whereas the container document will preferably conform to XML schema defined in accordance with ETSI TS 102 690 with the exception that XCAP references will preferably be used where applicable, to reference documents stored under the Containers resources. The accessPermission document under users' tree will preferably conform to XML schema defined in accordance with ETSI TS 102 690 with the exception that XCAP references will preferably be used where applicable, to reference documents stored under the Access-Rights resources. In addition to conforming to the XML schema, the XDMS will preferably ensure that every identity allocated to a Container Collection resource is unique. The request originator will preferably be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

There are two naming convention options for storing Container Collection XDM documents. In option 1, as shown in FIG. 19, there will preferably be only two Container Collection resource XDM documents per XUI. The well-known name of the main Container Collection resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown in FIG. 20), there will preferably be six well-known documents. The well-known name of the main Container Collection resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well known document is “accessPermission”. The document selector to access the accessPermission XDM document will preferably be “[auid]/users/[xui]/accessPermission”. The fourth well known document is “container”. The document selector to access the container XDM document will preferably be “[auid]/users/[xui]/container”. The fifth well known document is “containerAnnc”. The document selector to access the containerAnnc XDM document will preferably be “[auid]/users/[xui]/containerAnnc”. Finally, the last well known document is “accessStatus”. The document selector to access the accessStatus XDM document will preferably be “[auid]/users/[xui]/accessStatus”. For either option there is preferably only a single instance for every document

The XDMS server will preferably authorize requests for all operations on XDM documents located under the XUI tree using the accessPermission document under the same XUI tree for that purpose.

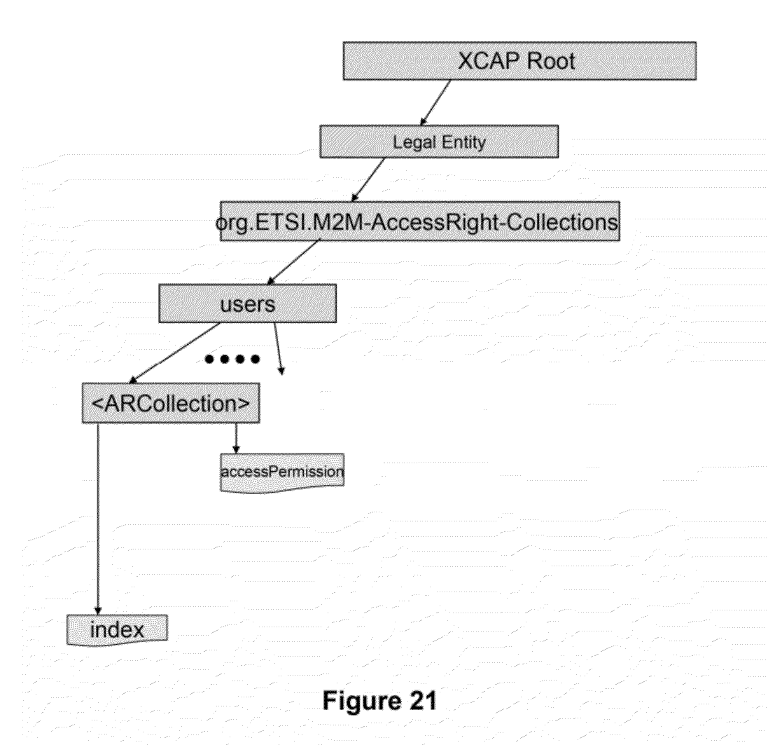

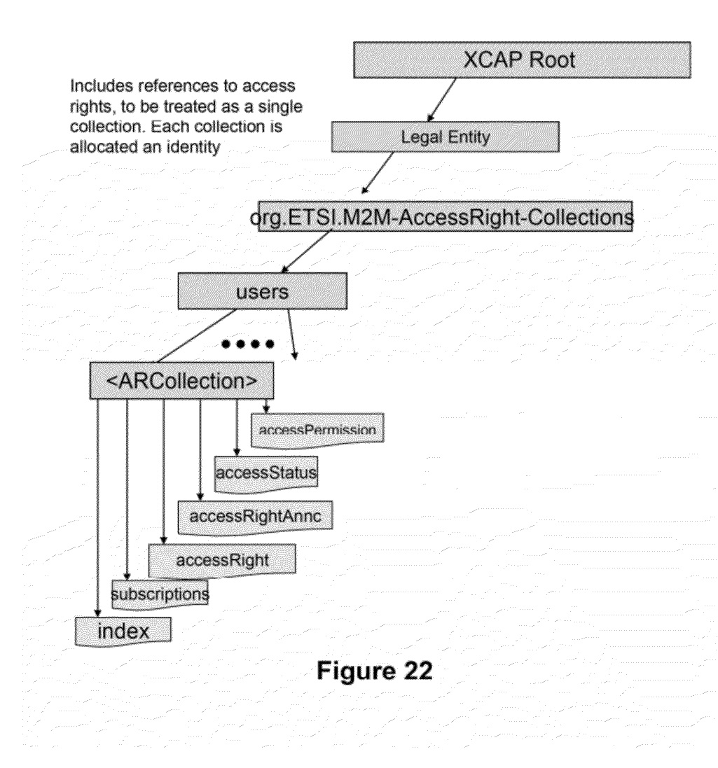

The Access-Right Collection Application Usage allows an M2M entity to be able to create/modify/delete a collection of Access-Right resources. Each Access-Right Collection resource that is created will preferably be allocated a unique identity that is under the users' tree beneath the AUID tree allocated to the Access-Right Collection resource. The AUID for the examples of FIGS. 21 and 22 will preferably be “org.ETSI.M2M-AccessRight-Collections”. The MIME type for the various XDM documents for the AccessRight Collection resource will preferably be as follows: the index document, accessStatus document, accessPermission document, subscriptions document, accessRight document, and accessRightAnnc document under users' tree, per XUI, will preferably be defined in accordance with ETSI TS 102 690.

The default namespace will preferably be “urn:etsi:xml:xdm:M2M-AccessRight-Collections”. The Access-Right Collections resource XDM documents will preferably conform to the following XML schemas: the index document, the accessStatus document, the subscriptions document, and the accessRightAnnc document under users' tree will preferably conform to XML schema defined in accordance with ETSI TS 102 690, whereas the accessRight document will preferably conform to XML schema defined in accordance with ETSI TS 102 690 with the exception that XCAP references will preferably be used where applicable, to reference documents stored under the Access-Right resources. The accessPermission document under users' tree will preferably conform to XML schema defined in accordance with ETSI TS 102 690 with the exception that XCAP references will preferably be used where applicable, to reference documents stored under the Access-Rights resources

In addition to conforming to the XML schema, the XDMS will preferably ensure that every identity allocated to an Access-Right Collection resource is unique. The request originator will preferably be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

There are two options for storing AccessRight Collection XDM documents. In option 1, illustrated in FIG. 21, there will preferably be only two Access-Right Collection resource XDM documents per XUI. The well-known name of the main AccessRight Collection resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown in FIG. 22), there will preferably be six well-known documents. The well-known name of the main AccessRight Collection resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well known document is “accessPermission”. The document selector to access the accessPermission XDM document will preferably be “[auid]/users/[xui]/accessPermission”. The fourth well known document is “accessRight”. The document selector to access the accessRight XDM document will preferably be “[auid]/users/[xui]/accessRight”. The fifth well known document is “accessRightAnnc”. The document selector to access the accessRightAnnc XDM document will preferably be “[auid]/users/[xui]/accessRightAnnc”. Finally, last well known document is “accessStatus”. The document selector to access the accessStatus XDM document will preferably be “[auid]/users/[xui]/accessStatus”. For either option there is preferably only a single instance for every document. The XDMS server will preferably authorize requests for all operations on XDM documents located under the XUI tree using the accessPermission document under the same XUI tree for that purpose. The Application Collection Application Usage allows an M2M entity to be able to create/modify/delete a collection of Application resources. Each Applications Collection resource that is created will preferably be allocated a unique identity that is under the users' tree beneath the AUID tree allocated to the Applications Collection resource.

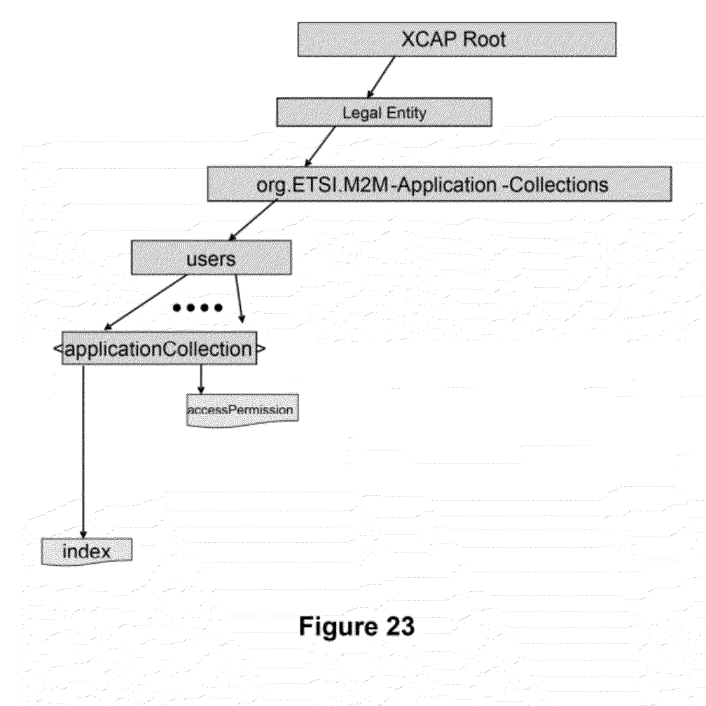

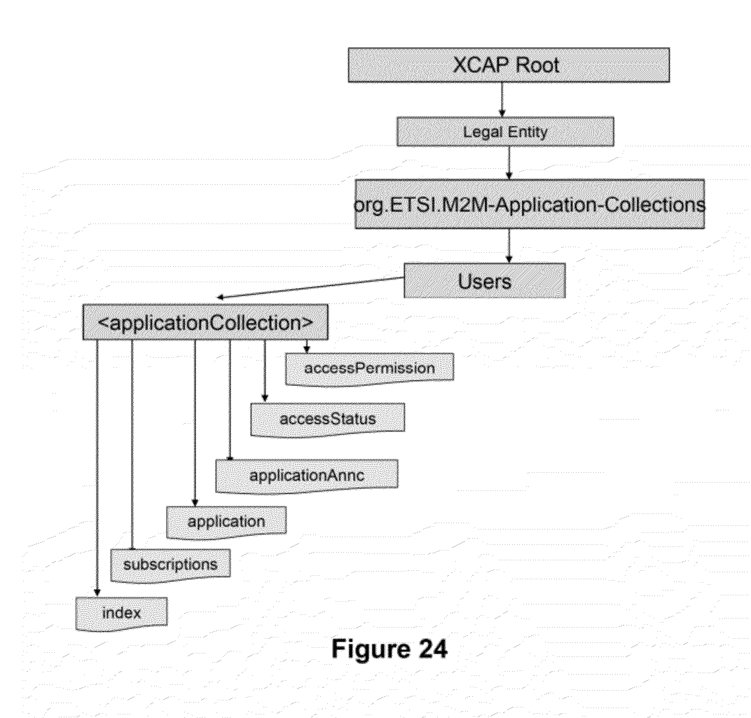

The AUID for the example of FIGS. 23 and 24 will preferably be “org.ETSI.M2M-Applications-Collections”. The MIME type for the various XDM documents for the Applications Collection resource will preferably be as follows: index document, accessStatus document, accessPermission document, subscriptions document, application document, and applicationAnnc document under users' tree, per XUI, will preferably be defined in accordance with ETSI TS 102 690 The default namespace will preferably be “urn:etsi:xml:xdm:M2M-Applications-Collections”

The Applications Collection resource XDM documents will preferably conform to the following XML schemas: index document, accessStatus document, subscriptions document, and applicationAnnc document each under users' tree will preferably conform to XML schema defined in accordance with ETSI TS 102 690, whereas the application document will preferably conform to XML schema defined in accordance with ETSI TS 102 690 with the exception that XCAP references will preferably be used where applicable, to reference documents stored under the Applications resources. The accessPermission document under users' tree will preferably conform to XML schema defined in accordance with ETSI TS 102 690 with the exception that XCAP references will preferably be used where applicable, to reference documents stored under the Access-Rights resources. In addition to conforming to the XML schema, the XDMS will preferably ensure that every identity allocated to an Announced-Applications Collection resource is unique. he request originator will preferably be extracted from the X-3GPP-Asserted-Identity HTTP header and will preferably be used by the XDMS for validating access rights for the requested operation before the operation is accepted. The semantics for the data is preferably defined in accordance with the relevant sections of ETSI TS 102 690.

There are two naming convention options for storing Application Collections XDM documents. In option 1, as shown in FIG. 23, there will preferably be only two Application Collection resource XDM documents per XUI. The well-known name of the main Application Collection resource document will preferably be “index”. The document selector to access the “index” XDM document will preferably be “[auid]/users/[xui]/index”. The second well known document is “accessPermission”. The document selector to access the accessPermission XDM document will preferably be “[auid]/users/[xui]/accessPermission”. The index document encompasses all the information in option 2 below (except the accessPermission which is identical in both options)

In option two (shown in FIG. 24), there will preferably be six well-known documents. The well-known name of the main Applications Collection resource XDM document will preferably be “index”. The document selector to access the “index” XDM document will preferably be “[auid]/users/[xui]/index”. The second well known document is “subscriptions”. The document selector to access the subscriptions XDM document will preferably be “[auid]/users/[xui]/subscriptions”. The third well known document is “accessPermission”. The document selector to access the accessPermission XDM document will preferably be “[auid]/users/[xui]/accessPermission”. The fourth well known document is “application”. The document selector to access the application XDM document will preferably be “[auid]/users/[xui]/application”. The fifth well known document is “applicationAnnc”. The document selector to access the applicationAnnc XDM document will preferably be “[auid]/users/[xui]/applicationAnnc”. Finally, the last well known document is “accessStatus”. The document selector to access theaccessStatus XDM document will preferably be “[auid]/users/[xui]/accesStatus”. For either option there is preferably only a single instance for every document. The XDMS server will preferably authorize requests for all operations on XDM documents located under the XUI tree using the accessPermission document under the same XUI tree for that purpose.

As noted above, the XDMS makes assumptions on how stored resources will be accessed that may be different than how the resources are preferably accessed in a machine-to-machine environment. Changing the manner in which an XDMS handles access to resources will result in a cascade of required changes in how nodes in an IMS network must interact. This is undesirable for a number of reasons. To accommodate this, the following mechanisms for access are introduced. From the perspective of the XDMS, access requirements can remain unchanged, while M2M specific nodes tailor their access mechanisms to these needs.

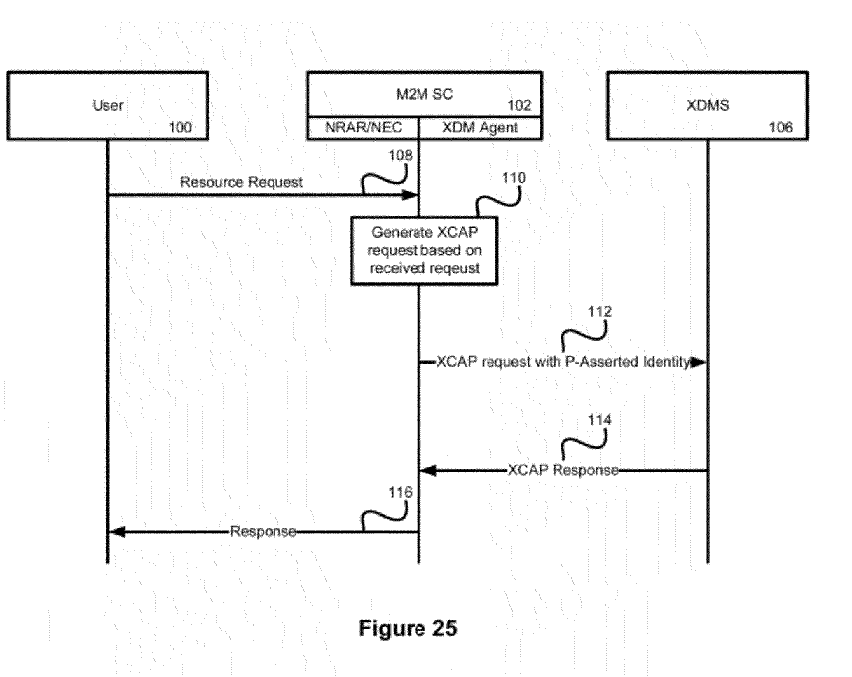

As illustrated in FIG. 25, a request 108 for a resource arises from a user node 100 (an M2M node) and is delivered to the Machine to Machine Service Capability Platform (M2M SC) 102. This request can be received in any of a number of different formats, either proprietary or standard driven, so long as they are in a format that is understandable to the M2M SC 102. The M2M SC 102 upon receipt of the request 108 (which could be a resource creation request) generates, in step 110, an XCAP request in accordance with request 108 and a P-Asserted-Identity. This generated XCAP request is forwarded to the XDMS 106 as XCAP request 112. As illustrated request 112 can be an XCAP Create resource request. One skilled in the art will appreciate that the generation of XCAP request 112 may be performed by an XDM agent resident in the M2M SC 102.

In response to receipt of the XCAP request 112, XDMS 106 issues a response 114 to the M2M SC 102, which in turn issues a response 116 to the originating node 100.

From the perspective of the XDMS 106, an XCAP request 112 is received and a response 114 is provided. The request 112 is associated with an identity that is relevant to the requested resource. Thus, from the perspective of the XDMS the request is legitimate and in accordance with established procedures. From the perspective of M2M device user 100, a request 108 for a resource is issued, and a response 116 is received. The M2M device user 100 need not understand that the XDMS 106 does not recognize the request as being associated with device 100. This allows interactions to occur at both nodes without needing to change the manner in which they already operate.

From the perspective of the M2M SC 102, request 108 is received and it forms the basis for the creation of a request 112. Request 112 is generated in accordance with the received request 108 and an identity. As illustrated, request 112 is preferably formatted as an XCAP compliant request regardless of the format of request 108. This ensures that the XDMS 106 is able to parse the request regardless of the format of the initial request. In response to sending request 112 with the appropriate identity information, M2M SC 102 receives a response 114, and forwards an appropriate response 116 to the end device 100.

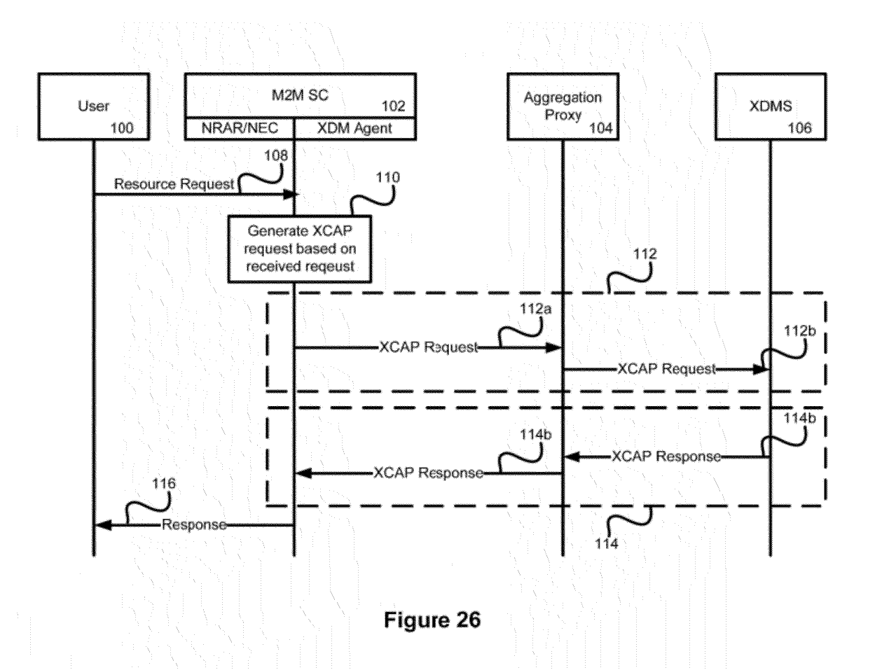

As will be appreciated, it is possible that the XDMS is not associated with a single M2M network. In such a case, it may be preferred to employ an aggregation proxy between the M2M SC and the XDMS. As will be understood, a secure tunnel may be employed between the aggregation proxy and the M2M SC. The manner in which such a secure tunnel is created, and the rules governing how it is secured are not germane to the instant discussion and may be agreed upon a priori by the parties involved. As illustrated in FIG. 26, the user device 100 generates request 108 as above, and transmits it to the M2M SC 102. The generation of the XCAP request 112 is performed by M2M SC 102 in step 110 as above (including the use of the asserted identity), but instead of sending request 112 directly to the XDMS 106, request 112a is transmitted to the aggregation proxy 104. At the aggregation proxy 104, requests from a plurality of different M2M SC Platforms can be received and aggregated for submission to the XDMS 106. Request 112a is forwarded as request 112b to the XDMS 106, either alone or along with other requests. Response 114a to request 112b is sent by the XDMS 106 to aggregation proxy 104, which in turn forwards response 114b to the M2M SC 102. In response to receipt of the response, M2M SC 102 transmits response 116 to the user.

As appropriate, when the use of an aggregation proxy is possible, the XDM may be required support communication between an internal XDM agent and the aggregation proxy. The protocol used may be a commonly understood protocol such as XCAP or XDCP. The M2M SC will preferably allow for the management of XDM resources such as create modify retrieve and delete, as handled by any XMDS that it can communicate with (either in the same network or in a connected network). Where no proxy is involved, the M2M SC may also be required to perform forwarding of XDM resources.

Aggregation proxies maybe required to support a number of services including the management of XDM resources that would otherwise be handled by an M2M SC as described above. Additionally, history information for XDM documents, the forwarding of XDM resources held by an XDMS, and management of access permissions for XDM documents, history functions related to preferences, and management (e.g. create modify delete and restore) of XDM resources requested by an XDMS but handled by another XDMS.

It may be necessary for the M2M SC 102 to determine the XDMS that the request should be sent towards. When an M2M device is unaware of the network topology it may simply specify a resource. The specified resource can then be used by the M2M SC 102 to determine which XDMS should be sent the request. This determination will typically require the M2M SC 102 to select an XDMS that may not be in the same network domain. When a different domain is selected, the request is typically sent through the aggregation proxy 104.

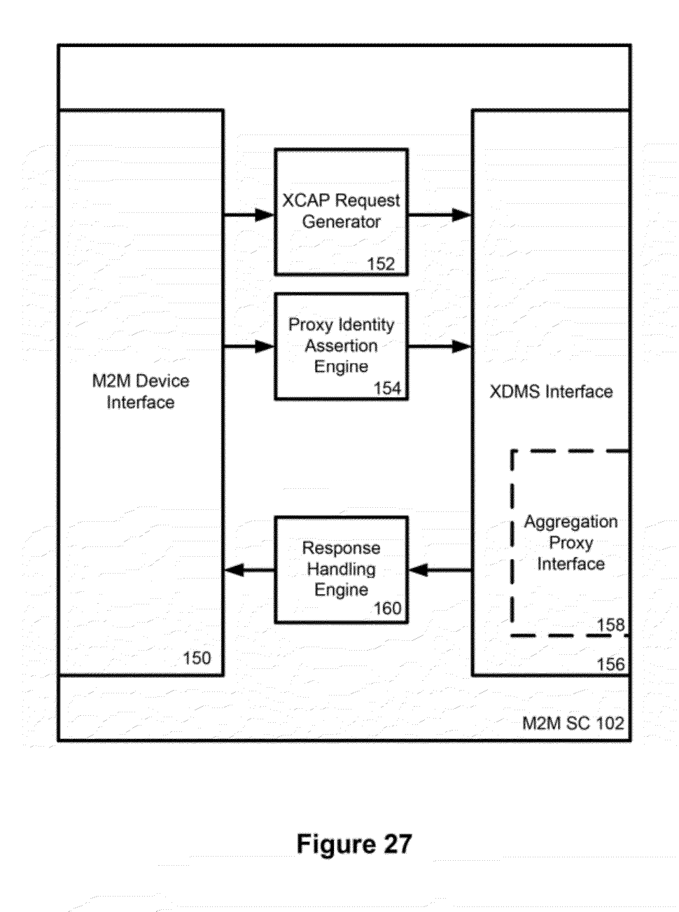

FIG. 27 illustrates an exemplary embodiment of M2M SC 102. An M2M device interface 150 allows interaction with M2M devices, such as user 100 of FIGS. 25 and 26. The requests received on the M2M device interface 150 are provided to XCAP Request Generator 152 and Proxy Identity Assertion engine 154. The XCAP request generator 152 creates an XCAP request in accordance with requests received from M2M devices and forwards the request to the XDMS interface 156. The Proxy Identity Assertion Engine 154 determines, in accordance with the received request the proxy identity that should be asserted with the XCAP request. This information is provided to the XDMS interface 156 so that it can be sent out to the XDMS. One skilled in the art will appreciate that an Aggregation Proxy Interface 158 can be optionally used by the XDMS interface 156 when the XDMS is not internal to the same hosted network. In such a case, it will be understood that the M2M SC 102 is transmitting the request towards the XDMS, through an aggregation server that acts as a gateway to a different network domain. Responses from the XDMS are received by the XDMS interface 156 (optionally through the Aggregation Proxy Interface 158 as required), and are provided to response handling engine 160. Response Handling Engine 160 will then determine the node or nodes to which the request applies, and will forward the response to the determined node in an appropriate format. This may require translating the format of the message to another format, and then sending the response towards the determined node through the M2M Device Interface 150.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of facilitating communication between an unmanaged machine-to-machine device and a network resource in a managed network, the method comprising:
receiving a request for the resource from the unmanaged device;
generating an Extensible Markup Language Configuration Access Protocol (XCAP) request in accordance with the received request; and
transmitting the generated request towards an Extensible Markup Language Document Management Server (XDMS) using an asserted identity determined in accordance with identities of both the resource and the unmanaged device.

2. The method of claim 1 wherein the step of receiving the request includes receiving a request in a format other than XCAP.

3. The method of claim 2 wherein the step of generating includes translating the request from a non-XCAP format to an XCAP format.

4. The method of claim 1 wherein the step of transmitting further includes selecting an XDMS in accordance with the resource associated with the received request.

5. The method of claim 1 wherein the step of transmitting includes transmitting the generated request to an aggregation proxy associated with the XDMS.

6. The method of claim 1 further including the step of receiving a response from the XDMS.

7. The method of claim 6 wherein the received response is formatted as an XCAP response.

8. The method of claim 6 further comprising the step of transmitting the received response to the unmanaged device.

9. The method of claim 8 wherein the step of transmitting the response includes translating the response from an XCAP compliant format to a format selected in accordance with characteristics of the unmanaged device.

10. The method of claim 6 wherein the step of receiving the response includes receiving the response from the XDMS via an aggregation proxy.

11. A Machine-to-Machine Service Capability Platform (M2M SC) for facilitating communication between an unmanaged machine-to-machine (M2M) device and a network resource in a managed network, the M2M SC comprising:
an M2M device interface for receiving messages from and sending messages to the unmanaged M2M device;
an Extensible Markup Language Configuration Access Protocol (XCAP) request generator for receiving a request for a resource from the unmanaged device, over the M2M device interface, and for generating an XCAP compliant request in accordance with the received request to be transmitted to an Extensible Markup Language Document Management Server (XDMS) selected in accordance with the requested resource;
a proxy identity assertion engine for determining an identity associated with the request received in accordance with an identity of the unmanaged device;
an XDMS interface for sending the generated XCAP compliant request towards the selected XDMS using the determined identity, and for receiving responses from the selected XDMS.

12. The M2M SC of claim 11 wherein the XDMS interface includes an Aggregation Proxy interface for transmitting the generated XCAP compliant request to an aggregation proxy when the selected XDMS is in a different network domain.

13. The M2M SC of claim 11 further comprising a response handling engine for receiving a response from the selected XDMS over the XDMS interface, and for transmitting a response to the unmanaged device in accordance with the received response.

14. The M2M SC of claim 13 wherein the response handling engine receives the response as an XCAP response and transmits the response to the unmanaged device in a non-XCAP format.
